(19) United States
(12) Patent Application Publication
(10) Pub. No.: US 2023/0020826 A1
(43) Pub. Date: Jan. 19, 2023

(54) Debris Collecting System

(71) Applicant: Mark Banas, Parma, OH (US)

(72) Inventor: Mark Banas, Parma, OH (US)

(21) Appl. No.: 17/377,483

(22) Filed: Jul. 16, 2021

(51) Int. Cl. B23Q 11/00; B23B 51/04; B23B 45/00

(52) U.S. Cl. CPC B23Q 11/0046; B23B 51/0473; B23B 45/003; B23Q 11/0067; B23Q 11/0071

(57) ABSTRACT

A debris collection system for use in cutting or drilling holes in a ceiling with a hole saw. The debris collection system allows a user to avoid or limit exposure to dust and debris created by cutting or drilling overhead holes in drywall or wood. A clear rigid debris shield is temporarily attachable to the ceiling so that the user does not have to hold it in place while operating the hole saw. The hole saw is operably contained within a debris collection chamber defined within the debris shield when in use. A vacuum hose connects to a vacuum port in a cylindrical sidewall of the debris shield at one end and is attachable to a portable vacuum at an opposite end to create suction and remove debris from the debris collection chamber. A hose hanger is attachable to the ceiling between the debris shield and the portable vacuum to support the vacuum hose and keep it out of the way.

### FIELD OF THE INVENTION

The present invention generally relates to a debris collecting system, and more specifically to a drywall dust and debris collection system for use with a hole saw. Accordingly, the present specification makes specific reference thereto. However, it is to be appreciated that aspects of the present invention are also equally amenable to other like applications, devices, and methods of manufacture.

### BACKGROUND

Contractors, builders, and do it yourselfers who work with drywall are often exposed to high concentrations of dusts. Drywall dust is made of a combination of drywall and joint compound that enters the air when cutting or sanding the drywall. Drywall joint compounds are made from many ingredients, such as talc, calcite, mica, gypsum, silica, which have been associated with throat, and respiratory tract irritation. Dust that is dangerous is smaller in size than a human hair and is not visible to the human eye. Breathing this dust may cause persistent throat and airway irritation, coughing, phlegm production, and breathing difficulties similar to asthma or reactive airway disease.

Drywall joint compound manufacturers recognize that workers might be exposed to too much dust during drywall sanding. The National Institute for Occupational Safety and Health warns people to avoid generating dust and to use respiratory protection when cutting drywall. One way to cut dust exposures is by using proper ventilation. However, this is not always followed in actual work practice. When respiratory protection is worn, it is often used incorrectly with no or limited training, proper selection, or fit.

Portable vacuums have been used to capture and remove the dust before the worker is exposed to it when sanding or cutting. In addition to lower exposures, vacuum systems can dramatically reduce dust exposures. This working environment is more comfortable, less irritating to eyes, nose, and throat, and less likely to require respiratory protection. Additionally, this can result in a cleaner environment that reduces dirt, cleanup time, and cleaning floors and carpets.

While a vacuum system is desirable, it is not practical for many applications. For example, cutting holes in a drywall ceiling requires both hands of the worker just to cut the hole. Using a portable vacuum would require a second worker to hold the vacuum in the area of the cutting. There are existing debris shields that surround the hole saw and collect the dust and debris by gravity. Unfortunately, they can obscure the vision of the operator and add to the weight of the tool. Any additional weight creates complications when working overhead.

Accordingly, there is a great need for a way to limit exposure of a worker to drywall dust. There is also a need for a way for a way to cut or drill holes in drywall overhead without dust expanding out of the immediate hole sawing area contaminating the entire room. Similarly, there is a need for a way to visualize the work area while cutting a hole that creates dust. Further, there is a need for a way to permanently contain and remove the dust from cutting or drilling overhead holes in drywall, plaster, or wood.

In this manner, the improved commemorative system of the present invention accomplishes all of the forgoing objectives, thereby providing an easy solution for containing dust generated from sawing holes in drywall. A primary feature of the present invention is a dust collection system that immediately contains dust created from a hole sawing operation. The present invention allows the user to cut holes in drywall overhead without becoming contaminated by the dust or debris created by sawing operations. Finally, the improvement of the present invention is capable of allowing the user to visualize the work area throughout and collect and safely remove and contain the dust and debris for later disposal.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a debris collecting system. The debris collecting system is configured to retain and collect dust and debris that is created when using a hole saw or drill to create holes in a surface, particularly an overhead surface, such as a ceiling. The debris collecting system comprises a debris shield, a vacuum port, and a plurality of mounting brackets.

The debris shield is generally transparent and rigid in construction. The debris shield comprises a cylindrical sidewall, a rim, and a circular top. The cylindrical sidewall comprises an interior surface and an exterior surface. The cylindrical sidewall terminates at one end in a rim which defines a base opening in the debris shield. The rim may be configured to fit a flat surface. Alternatively, the rim may comprise a compressible element for conforming to an irregular surface. The circular top is attached to the cylindrical sidewall opposite the rim to define a debris collecting chamber within. The circular top comprises a center aperture sized to accept a hole saw arbor or a hole saw driver. A ring located on either side of the surface at the hole is slightly smaller in size than the hole itself. This ring prevents the spinning arbor and/or chuck of the hole saw driver from impinging on the shell of the dust collector shield and cracking it. This ring is replaceable.

The vacuum port penetrates the cylindrical sidewall. The vacuum port is sized to accept a vacuum hose and may comprise a vacuum hose connector. A. securing component is used to connect the vacuum hose to the vacuum port or the vacuum hose connector.

The plurality of mounting brackets are configured to secure the debris shield to the surface. Each mounting bracket is attached to the exterior surface of the cylindrical sidewall via a sidewall attachment portion. A surface attachment portion extends perpendicularly from the sidewall attachment portion at the rim of the debris shield. Each surface portion is temporarily attachable to the surface with a mechanical fastener to secure the debris shield against the surface and to a secure structural component of a building system. Each surface attachment portion may be adjustable in length.

The debris collection system may further comprise a lighting element. The lighting element is attachable to the interior surface of the debris shield for improving visibility. The debris collection system may further comprise a distance determining component. The distance determining component is positional on the exterior surface of the debris shield for properly locating it on a ceiling.

The debris collection system may further comprise a hose support component or hanger, a vacuum hose, and a vacuum. The hose support component comprises a ceiling strap and a hose engaging element. The ceiling strap is attachable to the surface with a mechanical fastener to secure the hose support component to the surface. The vacuum hose is attachable at one end to the vacuum port and at the opposite end to the vacuum. The vacuum hose is supportable by the hose support component at some point along its length. A debris separator may be positioned in-line between the debris shield and the vacuum.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a debris collecting system of the present invention for use with a hole saw in accordance with the disclosed architecture.

FIG. 2 illustrates a perspective view of a debris shield of the debris collecting system of the present invention attached to a ceiling for use with the hole saw in accordance with the disclosed architecture.

FIG. 3 illustrates an underneath perspective view of the debris shield of the debris collecting system of the present invention for use with the hole saw in accordance with the disclosed architecture.

FIG. 4 illustrates a perspective view of the debris collecting system of the present invention for use with the hole saw in accordance with the disclosed architecture.

FIG. 5 illustrates an overhead view of the debris shield of the debris collecting system of the present invention for use with the hole saw in accordance with the disclosed architecture.

FIG. 6 illustrates a perspective view of the debris shield, a vacuum hose, and a hose support component of the debris collecting system of the present invention for use with the hole saw in accordance with the disclosed architecture.

FIG. 7 illustrates a side view of a portable vacuum and a debris separator of the debris collecting system of the present invention for use with the hole saw in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a dust catcher or dust control tool that helps to protect people and property from the health-affecting and dispersive dust of drywall and wood hole sawing. It can be used with four to six inch diameter, and possibly smaller size, electric drill-driven hole saws in conjunction with a portable shop vac for dust capture. With a 99% efficient filter down to one micron particles in the shop-vac, the system would help to safeguard people and property. An optional auxiliary centrifugal air separator can be used upstream of the shop vac filter to protect the 99% filter. The shop vac used must have sufficient air pressure in order to be able to draw exhaust air into the dust catcher, down the air hose, dust air separator, final filter in the shop vac, and shop vac discharge.

The dust catcher helps to contain dust from expanding out into the space from the hole sawing operations. The dust catcher catches many more particles of fine dust than would be capable with a non-exhausting dust bowl or other containment around a hole saw that has no dynamic exhaust. The present invention is advantageous in that it is effective in dust capture and containment especially in the small size particles in drywall dust, than other existing nondynamic exhausting systems.

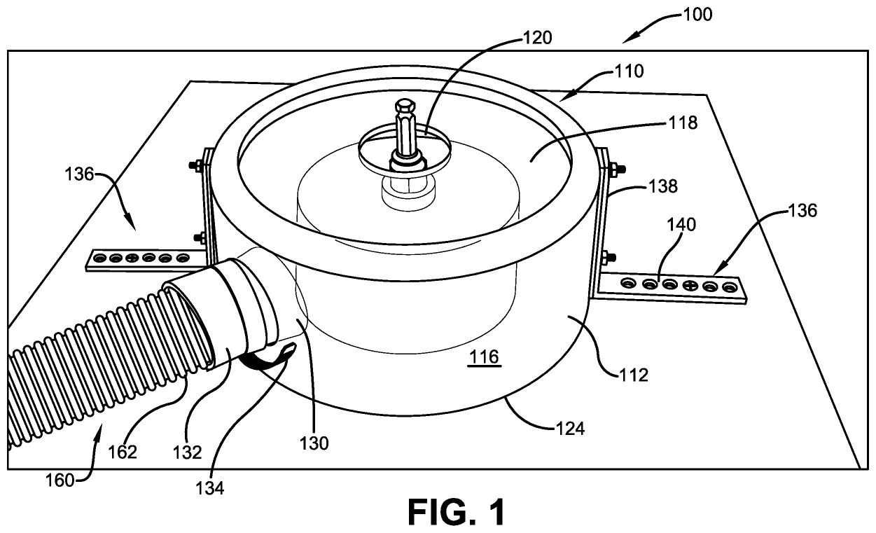

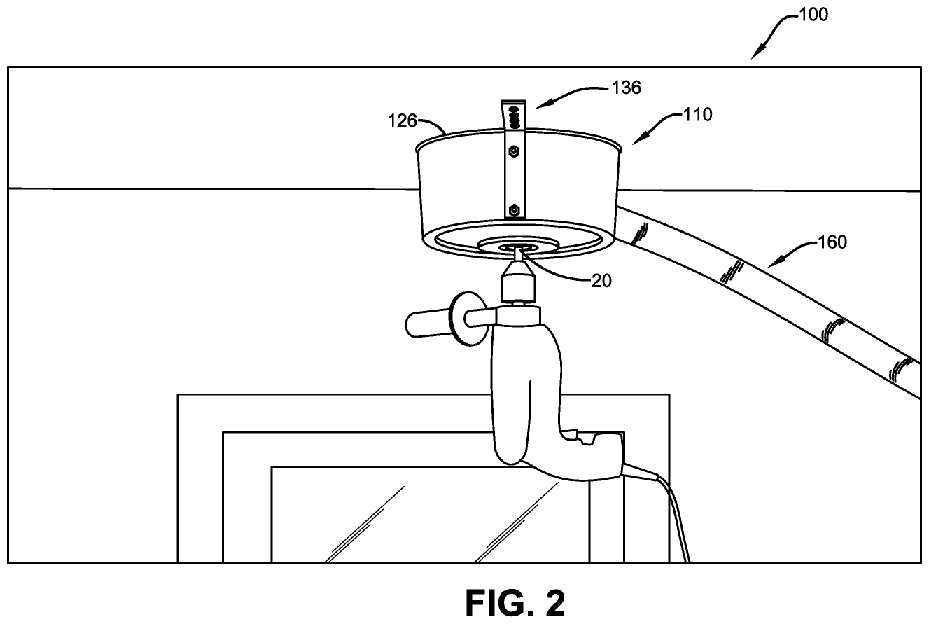

Referring initially to the drawings, FIGS. 1-7 illustrate a debris collecting system 100. The debris collecting system 100 is configured to retain and collect dust and debris created when using a hole saw 10 or drill to create holes in drywall, plaster, or wood surfaces. The debris collecting system 100 is configured to limit exposure to dust and debris created by cutting or drilling overhead holes. As illustrated in FIG. 2, a clear shield is temporarily attachable to the ceiling surface support structure so that the user does not have to hold it in place while operating the hole saw 10. The hole saw 10 is operably contained within a collection chamber defined within the shield when the hole saw is in use.

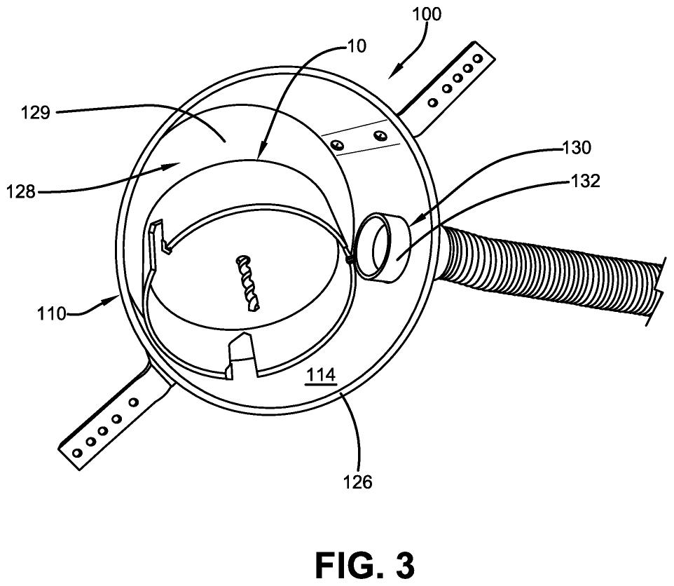

As illustrated in FIG. 1, the debris collecting system 100 comprises a debris shield 110, a vacuum port 130, and a plurality of mounting brackets 136. The debris shield 110 is generally transparent and rigidly noncompressible in construction. This is advantageous in the debris shield 110 keeping its shape when under a vacuum. The debris shield 110 may be manufactured from any rigid transparent or translucent plastic or polymer, such as polycarbonate, polyethylene terephthalate, polyvinyl chloride, polypropylene, polystyrene, or the like. The debris shield 110 comprises a cylindrical sidewall 112, a rim 124, and a circular top 118. The cylindrical sidewall 112 comprises an exterior surface 116 and an interior surface 114 as illustrated in FIG. 3. Alternatively, the sidewall may be otherwise geometrically shaped instead of cylindrical. The debris shield 110 typically range from approximately between six and twelve inches in diameter at the open, ceiling-contact end with a depth of approximately three to six inches but may be larger or smaller in diameter or depth as desired.

The cylindrical sidewall 112 terminates at one end in the rim 124. The rim 124 defines a base opening 128 in the debris shield 110. The rim 124 may be configured to fit snugly against a flat surface, such as a smooth drywall ceiling. Alternatively, the rim 124 may comprise a compressible element 126, such as a gasket, ring, liner, or similar sealing ring, for conforming to an irregular surface as illustrated in FIG. 3. The compressible element 126 allows the rim 124 to be compressible and adapt to and snugly fit an irregular surface, such as a textured ceiling.

The circular top 118 is attached to the cylindrical sidewall 112 disposed opposite the rim 124. The circular top 118 and the cylindrical sidewall 112 define a debris collecting chamber 129 within the debris shield 110. The circular top 118 comprises a center aperture 120 sized to accept a hole saw arbor 20 or a hole saw 10. The center aperture 120 typically ranges between approximately one and six inches in diameter. Arbors, also called mandrels, are designed to connect the hole saw with a thread in the cap of the hole saw to a drill chuck as well as hold the pilot bit. As such, the hole saw 10 can rotate freely within the debris shield 110 while the dust is contained within while the drill remains outside. The center aperture 120 also permits some airflow into the debris collection chamber 129 when a vacuum is applied.

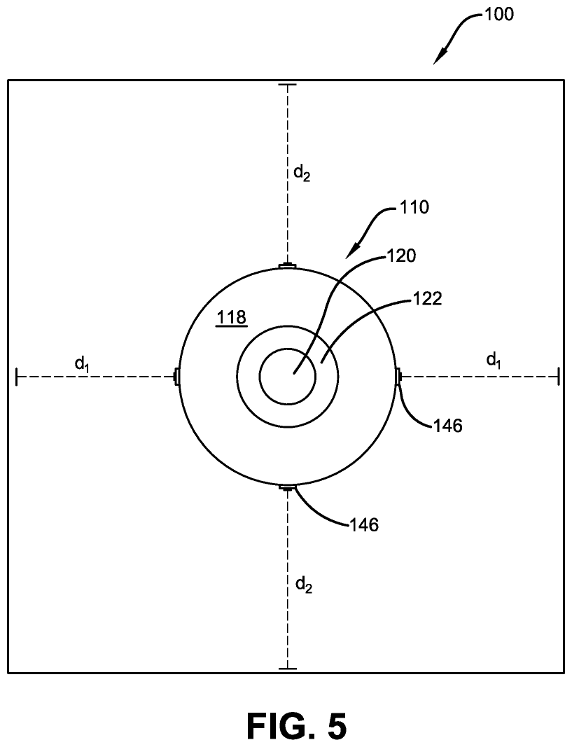

Alternatively, a diameter reducing element 122 can be positioned over a portion of the center aperture 120 and attached to the circular top 118 as illustrated in FIG. 5 to reduce the diameter of the center aperture 120 when using smaller sized hole saws. The diameter reducing element 122 may be a rubber or other semi-rigid elastic protection ring that circumvents the center aperture 120 in the circular top 118. A center hole of the ring is slightly smaller in size than the center aperture 120. This elastic ring prevents the spinning arbor 20 or chuck of the hole saw driver from impinging on the shell of the debris shield 110 and cracking it. This ring is replaceable. Target markings on the debris shield 110 on both the sidewall 112 and the surface with the hole are used to align with markings on the ceiling surface to calibrate the location of the debris shield 110 and pilot drill of the hole saw with the desired hole location at the ceiling.

The vacuum port 130 penetrates the cylindrical sidewall 112. The vacuum port 130 is sized to accept a vacuum hose 160 and may comprise a vacuum hose connector 132. The vacuum hose connector 132 is may be a tube with a collar extending out of the cylindrical sidewall 112 substantially perpendicularly. A securing component 134, such as a ring clamp, tubing clamp, or similar adjustable clamp, is used to attach to this tube and fastened to allow the connector 132 to spin freely in the sidewall 112. The tube is constrained longitudinally between the raised tube collar and the securing component 134, such as a pipe clamp, on the other side of the sidewall 112. This tube connector may have internal threads that screw on to and engage the vacuum hose 160 allowing it to spin.

The plurality of mounting brackets 136 are configured to secure the debris shield 110 to the surface. Each mounting bracket 136 comprises a sidewall attachment portion 138 and a surface attachment portion 140. Each mounting bracket 136 is attached to the exterior surface 116 of the cylindrical sidewall 112 via the sidewall attachment portion 138 using mechanical fasteners or adhesive. The surface attachment portion 140 is used as a debris shield support and extends substantially perpendicularly from the sidewall attachment portion 138 at approximately the level of the rim 124 of the debris shield 110. Each surface attachment portion 140 is temporarily attachable to the ceiling surface with a mechanical fastener to secure the debris shield 110 against the surface and connected to the structure above.

Drywall, plaster, plasterboard, or similar non-structural elements would be incapable of holding up the weight of the dust catcher hole saw and drill driver and are not to be employed in this manner. Each surface attachment portion 140 may be adjustable in length. Each surface attachment portion 140 may comprise an extension element 142 for increasing a length of each surface attachment portion 140. The user can simply screw the surface attachment portions 140 onto the ceiling so that the debris shield 110 does not need to be supported by the user. When complete, the user then unscrews the surface attachment portions 140, exposes the cut hole and can then patch the screw holes. Each surface attachment portion 140 is intended to be held against the surface of the ceiling by secure mechanical fastener. The unit is typically not intended to have fasteners only into gypsum board, plaster, or plasterboard.

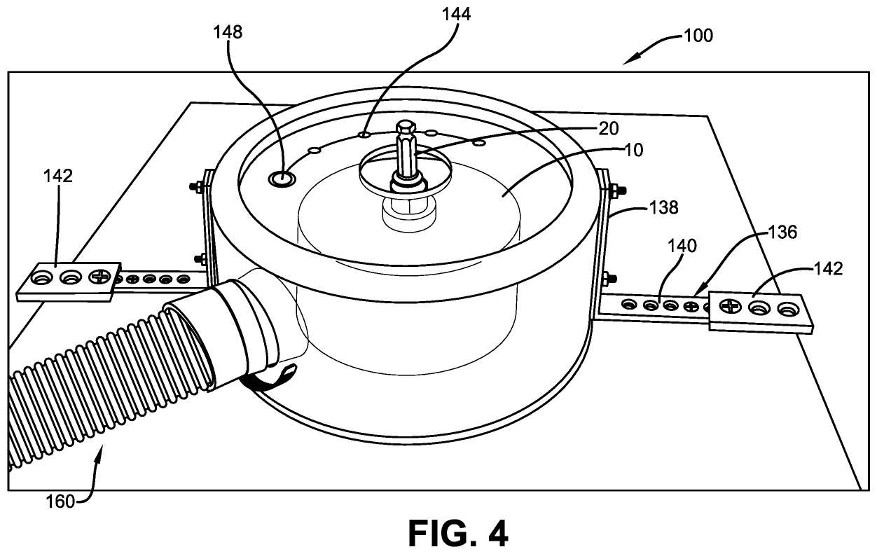

As illustrated in FIG. 4, the debris collection system 100 may further comprise a lighting element 144. The lighting element 144 is attachable to the interior surface 114 of the debris shield 110 for improving visibility. The lighting element 144 may be a LED strip or similar lighting system that is powered by a battery 148. As illustrated in FIG. 5, the debris collection system 100 may further comprise a distance determining component 146. The distance determining component 146 is positional on the exterior surface 116 of the debris shield 110. The distance determining component 146 is used for properly locating or centering the debris shield 110 on a ceiling. The distance determining component 146 may be a plurality of range finders or laser tape measures powered by the battery 148 placed at right angles or opposite each other configured to measure distance to a wall.

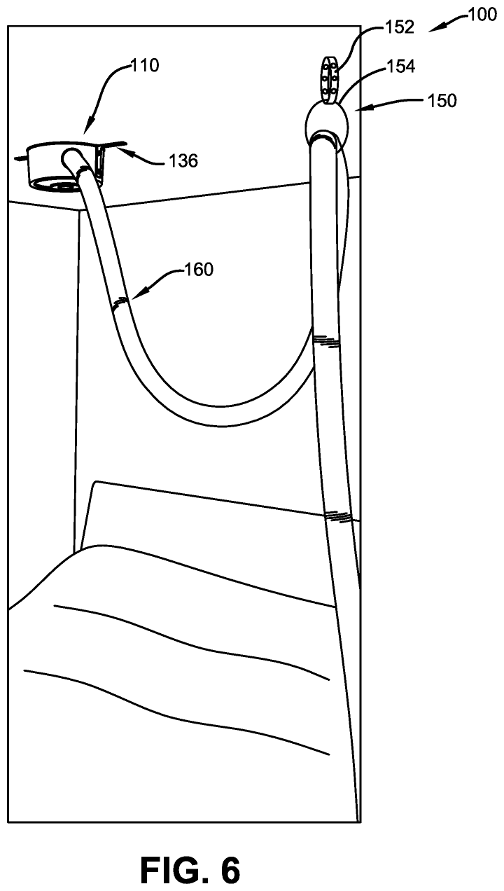

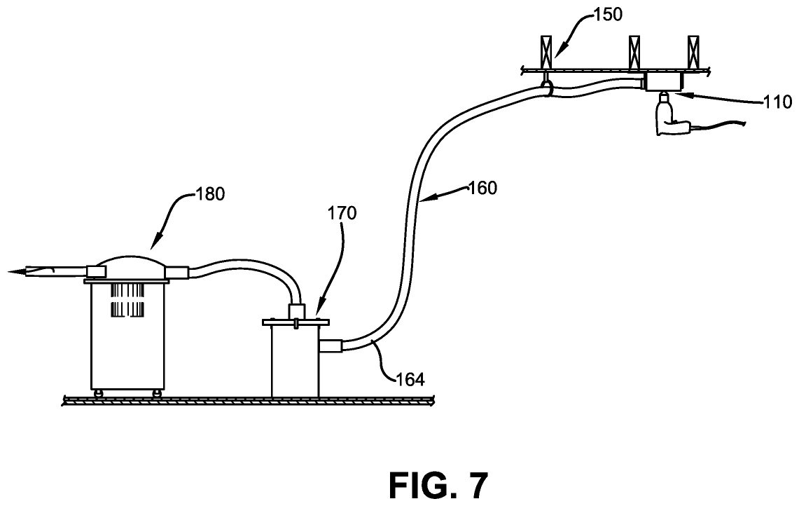

As illustrated in FIGS. 6 and 7, the debris collection system 100 may further comprise a hose support component 150, the vacuum hose 160, and a vacuum 180. The hose support component 150 functions as a hose hanger and is attachable to the surface away from the debris shield 110 to provide support for the vacuum hose 160 weight and to keep it out of the work area. The hose support component 150 comprises a ceiling strap 152 and a hose engaging element 154. The ceiling strap 152 is attachable to the surface with a mechanical fastener, in a similar manor as each of the surface attachment portions 140 of the mounting brackets 136 to secure the hose support component to the surface. The hose engaging element 154 is configured to hold the vacuum hose 160 without compressing the vacuum hose 160.

The vacuum hose 160 may be a shop vacuum type hose. The vacuum hose 160 is connectable or attachable at one end 162 to the vacuum connector 134 in the debris shield 110 and at the opposite end 164 to the vacuum 180. The vacuum hose 160 is supportable by the hose support component 150 at some point along its length. The vacuum 180 is typically a portable vacuum, such as a shop vacuum or wall vacuum. The vacuum 180 may employ a dust filter and may exhaust to the workspace, or to an outside environment. The vacuum 180 may be used to provide some “suction” to hold the debris shield 110 to the ceiling to initially assist with installation of the mounting brackets 136 for a single user installation.

The debris collecting system 100 may further comprise a debris separator 170. The debris separator 170 may be positioned in-line between the debris shield 110 and the vacuum 180. The debris separator 170 may be a centrifugal air separator configured to trap larger particulates that settle via gravity in the separator. The debris separator 170 connects to the vacuum hose 160 attached to the vacuum port 130 then to the vacuum 180 via an additional vacuum hose. An optional discharge hose may be installed at the outlet of the shop vac 180 and discharge through a termination plate at an exterior wall opening to the outside to discharge fine particles that the high efficiency filter cannot extract from the airstream. A sliding exhaust flange (not shown) configured to adjustably fit a window and the shop vac discharge will further control dust inside an enclosed space. A particulate counter may be added to the system to show efficiency of the dust collection.

The debris collection system 100 may further comprise a control and safety component. The system 100 must be controlled in a manner that maintains space cleanliness as well as operator safety. A master disconnect switch in the form of a portable electric outlet box with a master on-off switch (preferably with a light indicator) may be used to control the operation of the debris shield 110 and the hole saw driver. This will help assure hole sawing and dust extraction will not commence until the switch is turned on by the operator. This will confirm that exhaust is taking place before the drilling and cutting starts, and that the hole saw driver will most likely be attached to the arbor 20 of the hole saw 10 after the dust shield with the hole saw 10 inside has been secured at the ceiling. To help assure safety of the operator from inadvertently turning on the drill while fastening the driver to the arbor 20, the switch will be in the off position. After the driver is attached to the arbor 20 and the worker has the driver firmly in hand with both hands, the switch can be engaged and visually confirmed that power is on to both the exhaust and the driver. After the hole is cut, the switch can be turned off. The exhaust will then stop, and the worker can safely remove the driver from the arbor 20 of the drill if he so chooses.

Notwithstanding the forgoing, the debris collecting system 100 can be any suitable size, shape, and configuration as is known in the art without affecting the overall concept of the invention, provided that it accomplishes the above stated objectives. One of ordinary skill in the art will appreciate that the shape and size of the debris collecting system 100 and its various components, as show in the FIGS. are for illustrative purposes only, and that many other shapes and sizes of the debris collecting system 100 are well within the scope of the present disclosure. Although dimensions of the debris collecting system 100 and its components (i.e., length, width, and height) are important design parameters for good performance, the debris collecting system 100 and its various components may be any shape or size that ensures optimal performance during use and/or that suits user need and/or preference. As such, the debris collecting system 100 may be comprised of sizing/shaping that is appropriate and specific in regard to whatever the debris collecting system 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A debris collecting system for use with a hole saw comprising:
a debris shield comprising a cylindrical sidewall terminating in a rim at one end and a circular top comprising a center aperture disposed opposite the rim; and
a vacuum port penetrating the cylindrical sidewall; and
a plurality of mounting brackets attached to the cylindrical sidewall for securing the debris shield to a surface.

2. The debris collecting system of claim 1, wherein the rim defines a base opening in the debris shield.

3. The debris collecting system of claim 1, wherein the cylindrical sidewall and the circular top define a debris collecting chamber.

4. The debris collecting system of claim 1, wherein the debris shield is transparent.

5. The debris collecting system of claim 1, wherein the debris shield is noncompressible.

6. The debris collecting system of claim 1, wherein the rim is adaptable to an irregular surface.

7. The debris collecting system of claim 1, wherein the center aperture is sized to accept a hole saw arbor within.

8. The debris collecting system of claim 1 further comprising a diameter reducing element positional over or within the center aperture.

9. The debris collecting system of claim 1, wherein the vacuum port comprises a vacuum hose connector.

10. The debris collecting system of claim 1, wherein the plurality of mounting brackets each comprise a sidewall attachment portion and a surface attachment portion.

11. The debris collecting system of claim 6, wherein each surface attachment portion is adjustable in length.

12. The debris collecting system of claim 1 further comprising a lighting element attachable to an interior surface of the cylindrical sidewall.

13. The debris collecting system of claim 1 further comprising a distance measuring component attachable to an exterior surface of the cylindrical sidewall.

14. A debris collecting system for use with a hole saw comprising:
a transparent debris shield comprising a cylindrical sidewall terminating in a rim at one end and a circular top comprising a center aperture disposed opposite the rim; and
a vacuum port penetrating the cylindrical sidewall;
a plurality of mounting brackets attached to the cylindrical sidewall for securing the debris shield to a surface support structure;
a hose support component attachable to the surface; and
a vacuum hose connectable to the vacuum port connector and supportable by the hose support component.

15. The debris collecting system of claim 14, wherein the hose support component comprises a ceiling strap and a vacuum hose engaging element.

16. The debris collecting system of claim 14, wherein the rim of the debris shield is compressible.

17. The debris collecting system of claim 14, wherein the plurality of mounting brackets each comprise a sidewall attachment portion and a surface attachment portion.

18. The debris collecting system of claim 17, wherein each surface attachment portion is adjustable in length.

19. A debris collecting system for use with a hole saw comprising:
a transparent noncompressible debris shield comprising a cylindrical sidewall terminating in a rim at one end and a circular top comprising a center aperture sized to accept a hole saw arbor within disposed opposite the rim; and
a vacuum port penetrating the cylindrical sidewall;
a plurality of mounting brackets attached to the cylindrical sidewall for securing the debris shield to a surface structure;
a hose support component attachable to the surface;
a vacuum hose connectable to the vacuum port via a vacuum hose connector and supportable along its length by the hose support component; and
a portable vacuum connectable to the vacuum hose opposite the vacuum port.

20. The debris collecting system of claim 19 further comprising a debris separator in-line between the vacuum port and the portable vacuum.
